(19) United States
(12) Patent Application Publication
(10) Pub. No.: US 2011/0225884 A1
(43) Pub. Date: Sep. 22, 2011

(54) Biodegradable Memorial and Method of Making the Same

(76) Inventor: Kenneth Omar Johnson, Detroit, MI (US)

(21) Appl. No.: 13/050,172

(22) Filed: Mar. 17, 2011

Related U.S. Application Data
(60) Provisional application No. 61/314,780, filed on Mar. 17, 2010.

(51) Int. Cl. A01G 31/00; A01G 9/02

(52) U.S. Cl. 47/59 S; 47/65.7; 47/66.7

(57) ABSTRACT

The present invention provides methods and devices for the formation of biodegradable memorials. The present invention provides memorial devices that are biodegradable in natural environmental conditions and configured to provide and sustain plant life. In one exemplary embodiment, the present invention provides a biodegradable memorial configured for plant growth. The memorial device includes a substantially solid core growth medium capable of sustaining plant growth. The substantially solid core growth medium includes a first binder for maintaining a shape of the growth medium. The memorial further includes a first layer disposed over the growth medium, the first layer comprises a first mixture including seeds. The memorial further includes a second layer disposed substantially over the entirety of the growth medium and substantially solid core, the second layer comprises a biodegradable material configured to erode at a first rate to expose the first layer.

### CROSS-REFERENCE TO RELATED APPLICATION

The present application claims benefit of U.S. Provisional Patent Application No. 61/314,780, filed Mar. 17, 2010, the contents of which are hereby incorporated by reference in its entirety for all purposes.

### FIELD OF THE INVENTION

The present invention relates to biodegradable memorials and methods of making the same.

### BACKGROUND

The unexpected loss of a loved one leaves many individuals confused on how to move on. Unexpected losses occur in many circumstances including vehicle accidents, work accidents, violent criminal acts and otherwise. In any regard, there is no easy way to deal with the pain from the loss of a loved one.

One way individuals have coped with an unexpected loss, and often untimely losses, has been to memorialize the individual at the place where the accident occurred, such as along a road or sidewalk, in front of a building, store or home. Such memorials may include personal items or generic items such as stuffed animals, crosses, flowers or otherwise. However, while personal items may eventually be collected by an individual, other more generic items are often left behind.

Over time, the more generic items become weathered and unattractive. However, due to the nature of the loss, loved ones and other persons are fearful that removal of these items may ultimately be hurtful or disrespectful to family members. As such, these items continually become weathered and more unattractive until eventually a government agency is called upon to collect and remove these items. These collected items are then thrown away and eventually disposed of in landfills. As many of these memorial items are generally non-biodegradable or degrade only after many years, the disposing of these items cause further problems of trash accumulation in the United States and elsewhere.

In view of the foregoing, there is a need for improved methods and devices for memorializing loved ones, which eliminates or reduces the time and cost of collecting such items and also removes the uncomfortable task of having to remove the memorial. There is also a continual need to reduce the amount of non-biodegradable items that are placed in landfills.

### SUMMARY OF THE INVENTION

The present invention provides methods and devices for the formation of biodegradable memorials. The advantages of the present invention are predicated on the creation of memorial devices that are not only biodegradable and/or erodible under natural environmental conditions, but also configured to provide and sustain plant life upon degradation of all or a portion of the memorial device.

In view of the foregoing, in one exemplary embodiment, the present invention provides a biodegradable memorial configured for plant growth. The memorial includes a substantially solid core comprising a growth medium capable of sustaining plant life. The core includes a first binder for maintaining a shape of the growth medium. The memorial further includes a first layer disposed over the growth medium, the first layer comprises a first mixture including seeds. The memorial further includes a second layer disposed substantially over the entirety of the core, the second layer comprise of a biodegradable material configured to erode at a first rate to expose the first layer.

In another exemplary embodiment, the present invention provides a method of forming a biodegradable memorial. The method comprises the steps of: i) mixing a first binder with a growth medium configured for supporting plant life; ii) compressing the growth medium to form a substantially solid core, the compressed growth medium maintaining its shape upon release; iii) applying a first layer over the compressed solid core, the first layer includes a mixture of seeds and binder; and iv) applying a second layer substantially over the entirety of the first layer and the compressed growth medium, the second layer comprises a biodegradable material configured to erode at a first rate.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIGS. 1A and 1B illustrate exemplary embodiments of memorial devices of the present invention;

FIG. 2 illustrates a cross-sectional view of the memorial device shown in FIG. 1A;

FIGS. 3A through 3C illustrates the transformation of an exemplary memorial device from a fanciful character to a floral arrangement;

FIG. 4 illustrates an exemplary forming device for forming a core of a memorial device of the present invention;

FIG. 5 illustrates an exemplary application device for applying one or more layers to a core formed by a forming device;

FIG. 6 illustrates a partial cross-sectional view of an exemplary memorial device of the present invention; and

FIG. 7 illustrates a partial cross-sectional view of another exemplary memorial device of the present invention.

### DESCRIPTION OF THE PREFERRED EMBODIMENTS

In general, the present invention relates to methods and devices for providing non-toxic and self-disposing memorial devices. In one exemplary embodiment, a memorial device is formed that is configured to erode or partially erode, after a particular time period, to expose a layer of seeds and provide the ability of the seeds to germinate and grow. During germination and growth of the seed layer, the memorial device deteriorates to form a small mound for the growing plants which eventually form a plant or flower arrangement. It is contemplated that while the plant or flower arrangement continues to grow or live, the mound may continue to deteriorate to be generally flush with a corresponding ground surface. Accordingly, unlike other memorial devices, the memorial devices of the present invention do not require removal.

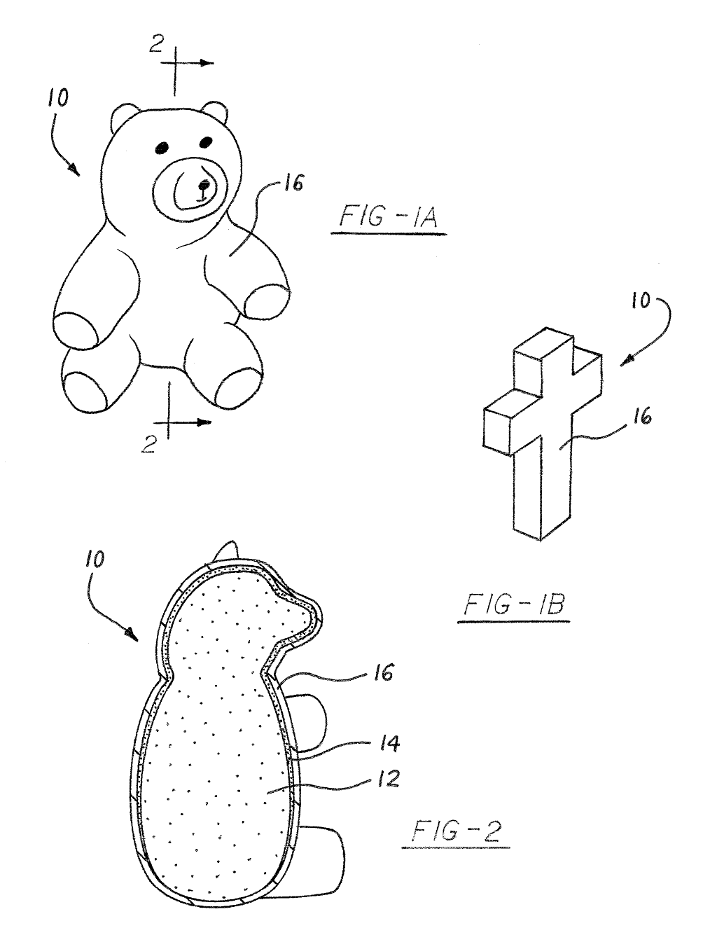

Referring to FIGS. 1A and 1B, several exemplary embodiments of biodegradable memorial devices 10 of the present invention are shown. The memorial devices 10 include a core 12 being formed of a material configured to sustain plant growth. The memorial devices 10 further include a seed or seeded layer 14 disposed over the core 12. The seed layer 14 is configured to germinate and grow into the core 12. The memorial devices 10 further include a biodegradable or erodible layer, hereinafter referred to as erodible layer 16, disposed over a substantial portion of the seed layer 14 and core 12. It is further contemplated that the erodible layer 16, or one or more additional layers 18, may be pigmented to create an aesthetically pleasing memorial.

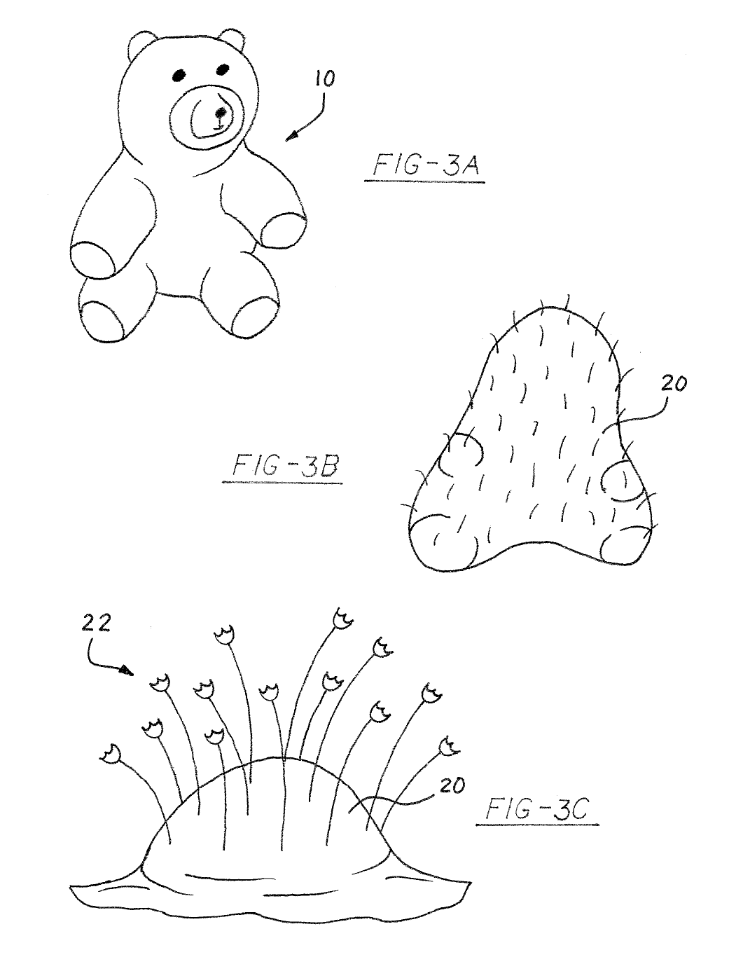

In one exemplary use, referring to FIGS. 3A through 3C, the memorial device 10 is placed outdoors and at a site chosen to honor a person who has passed. As the memorial device is exposed to elements of nature, such as rain and humidity, the erodible layer 16 begins to degrade exposing the seed layer 14. Continued exposure to rain, sun and humidity causes the seed layer 14 to germinate and grow into the core 12. During growth, as a result of the rain and humidity, plant growth or both, the core breaks down to form a mound 20. As the seed layer continues to grow, a flower or other plant arrangement 22 is formed.

In one exemplary embodiment, the memorial device 10 is shaped to provide significance as it relates to a person who has passed. For example, it is contemplated that the memorial device 10 may be shaped as a fanciful character such as teddy bear, kitten or otherwise. Other shapes contemplated for the memorial device includes crosses, sculptures or otherwise. It should be appreciated that other shapes are possible that may be particularly personal to the individual who has passed.

In greater detail, the growth medium forming the core 12 comprises one or more suitable materials for sustaining plant life. Examples of suitable material include dirt, rocks, moss, saw dust, straw combinations thereof or otherwise. It is also contemplated that the growth medium of the core 12 may be formed of a first mixture. For example, the growth medium may be formed of any combinations of the above referenced materials. It is also contemplated that one or more of the above materials can be combined with a binder or otherwise include a natural binding agent to maintain the growth medium together after forming. Such binding agents include heat activated adhesive, pressure activated adhesive or otherwise. Examples of suitable binding agents includes MagiGlue™ offered by Athena Environmental Sciences, Inc. at htt://www.buygreen.com/magiglue.aspx and Ukky glue Offered by Ukky at htt://www.littlefootprintstoys.com/store/Products/UK00001. However, in one exemplary embodiment the binding agent is non-toxic and is water soluble or otherwise is configured to erode over time in the presence of water or humidity to allow the formed core to lose shape and form mound 20.

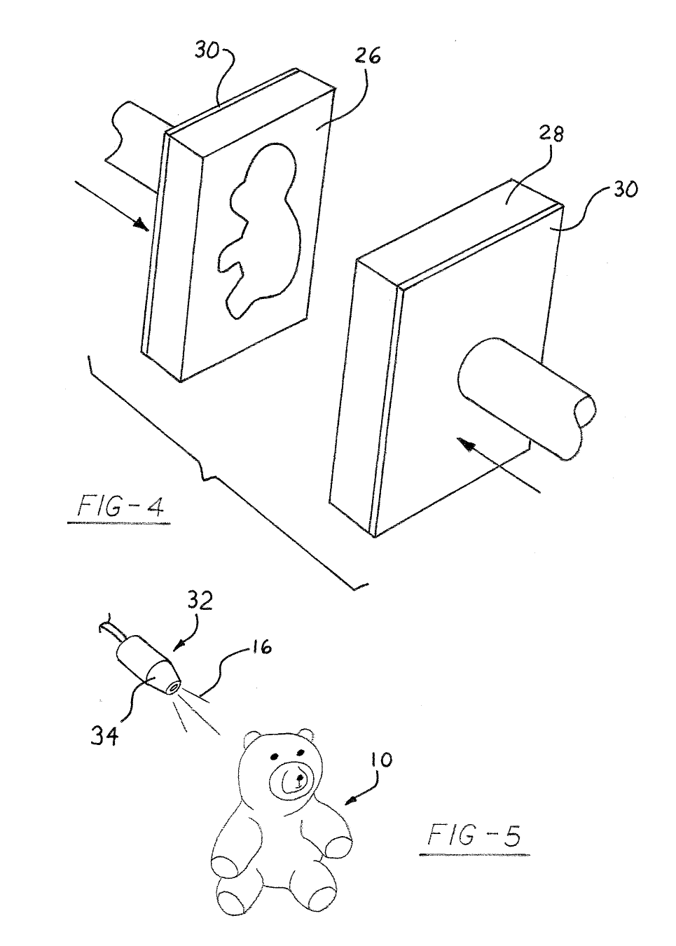

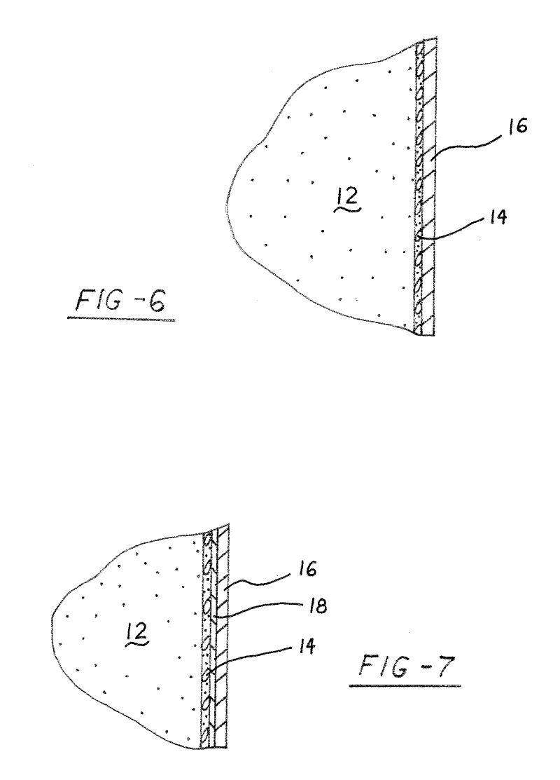

Formation of the core 12 is achieved through a suitable forming device and/or technique. In one exemplary embodiment, the suitable forming device and/or technique forms a substantially solid core 12. In one exemplary forming device, referring to FIG. 4, the forming device comprises a press mold assembly 24 having a first press member 26 and a second press member 28. Each of the first and second press member 26, 28 forms a cavity comprising a portion of the shape of the core 12. In one exemplary embodiment, the first, second or both press members 26, 28 include a heater 30. This is particularly advantageous when using heat activated binders, as described herein or otherwise. In operation, the first press member 26 and the second press member 28 compresses the growth medium to form a substantially solid core 12.

The seed layer 14 comprises a plurality of seeds formed in a layer over the core 12. The seed layer may be formed of one or more types of seeds for growing flowers or other type of plants. In one exemplary embodiment, the seed layer 14 includes one or more additional materials to form a second mixture. In one exemplary embodiment, the additional materials comprises a fertilizer, plant food or other material configured to encourage plant growth. In another exemplary embodiment, the additional material comprises a carrier configured to aid in the application of the seed layer 14 to the core 12. Accordingly, the additional material may include a binder, adhesive, a material carrier (such as a filler or otherwise) for the seeds, or otherwise.

The seed layer 14 is applied to the core 12 using a suitable device and application technique. Such devices and techniques can comprise hand application, spraying, dipping or otherwise. The seed layer includes a thickness and seed density suitable for generating a desired plant density extending from the core 12. In one exemplary embodiment, the seed layer 14 is applied to a majority of the surface area of the core 12. In another exemplary embodiment, as shown in FIG. 2, the seed layer is applied to an exposed or top surface of the core 12.

The erodible layer 16 is configured for providing limited protection to the seed layer 14 and growth medium 12 for a particular time period. In one configuration, as shown in FIG. 2, the biodegradable layer substantially surrounds the seed layer 14 and growth medium 12. It is contemplated that the biodegradable layer seals the seed layer 14 and growth medium 12 from the surrounding environment for a predetermined time period.

The erodible layer 16 provides limited protection, based upon environmental conditions it is exposed to, so as to control the time period of transformation from a fanciful character, or otherwise, to a flower or plant arrangement, as shown in FIGS. 3A through 3C. It is contemplated that the erodible layer 16 is configured to substantially seal or cover the seed layer 14 and growth medium 12 for at least about 2 weeks, 4 weeks, 2 months or more when exposed to the natural outdoor environment. However, it is also contemplated that the erodible layer 16 is configured to substantially dissolve, erode or degrade to expose the seed layer 14 and growth medium 12 within 6 months, 3 months or less when exposed to the natural outdoor environment. It should be appreciated that other configurations are possible.

Due to the various environmental outdoor conditions around the world, it is contemplated that the material forming the biodegradable layer and material thickness thereof, varies to achieve a desired protection of the seed layer 14 and core 12. The erodible layer 16 is formed of a material configured to erode over time due to exposure to environmental conditions. The biodegradable material may be rigid or flexible depending upon the material forming the layer. As an example, the erodible layer 16 can be formed of material used to form candy, e.g. sugar and corn syrup, or otherwise. In another example, the erodible layer 16 can be formed of a gel material. Other materials are contemplated. It is further contemplated that dependent upon the material forming the erodible layer 16, the thickness of the biodegradable material may also vary to achieve a desired protection period. In one exemplary embodiment, the thickness of the biodegradable material 16 is at least 0.1 mm, 0.2 mm, 0.5 mm, 1.0 mm, 2.0 mm or greater.

The erodible layer 16 is applied over the seed layer 14 and growth medium 12 using a suitable application technique. In one exemplary embodiment, referring to FIG. 5, the erodible layer 16 is applied using a spray device 30 including a suitable nozzle 32. The spray device 30 can be automated or manually used to form a generally consistent material thickness over the core 12. In another exemplary embodiment the seed layer 14 and growth medium 12 are dipped one or more times into a pool of material forming the erodible layer 16. Other applications and techniques are possible. The erodible layer 16 can be transparent, opaque or may include pigmentation as described below.

In one exemplary embodiment, the memorial device 10 further includes pigmentation to enhance the aesthetics of the memorial device. In one configuration, the seed layer 14, erodible layer 16 or both include a particular pigmentation corresponding to the fanciful character or otherwise to achieve a desired effect. Such pigmentation may be particularly advantageous for bringing fourth enhanced visual effects of the memorial device 10. It is contemplated that the memorial device may include multiple applications of erodible layer 16 to achieve the desired effect. In another configuration, the memorial device may include one or more additional layers 18 including pigmentation to achieve a particular aesthetic result. In this configuration, it is contemplated that the additional layer is disposed between the erodible layer 16 and seed layer 14 such that the pigmentation remains until degradation of the memorial device 10 begins.

The pigmentation is applied using any suitable means including automated or manual spraying, such as shown in FIG. 5. It is further contemplated that the pigmentation can be applied through manual painting. It is still further contemplated that the pigmentation can be applied through a dipping process. Still further, any combination of the above methods or otherwise may be used for applying pigmentation to the memorial device 10.

The memorial device 10 may be formed using any of the methods described herein. In one exemplary configuration, referring to FIGS. 4 and 5, the memorial device is formed through a press mold assembly 24. In this configuration, a first mixture comprising of a growth medium and binder is formed. The first mixture is placed within the press mold assembly 24 and compressed to form a core 12 that is substantially bound together. A seed layer 14 is then applied to the core 12 to provide a substantially consistent layer of plant seeds along an exposed surface of the memorial device, as shown in FIG. 2. An erodible layer 16 is sprayed or otherwise applied to the seed layer 14 and growth medium 12 to form a substantial seal about an exterior surface of the memorial device 10. The memorial device 10 is then placed at a site to honor a person who has passed. As the environmental condition begins to take effect on the memorial device 10, the erodible layer 16 dissolves to expose the seed layer 14 and growth medium 12. Water generated by rain or otherwise causes germination of the seeds within the seed layer 14 thereby causing growth thereof. As the plants from the seeds continue to grow, the binder maintaining the shape of the growth medium dissolves allowing the growth medium to form a mound. The plants created by the seeds of the seed layer 14 continue to grow to form a plant arrangement, and in one configuration a flower arrangement.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A biodegradable memorial configured for plant growth, the memorial comprising:
a substantially solid core growth medium capable of sustaining plant life, the substantially solid core growth medium including a first binder for maintaining a shape of the growth medium;
a first layer disposed over the growth medium, the first layer comprising a first mixture including seeds; and
a second layer disposed substantially over the entirety of the first layer, the second layer comprising an erodible material configured to erode at a first rate to expose the first layer.

2. The biodegradable memorial of claim 1, wherein the growth medium is shaped of a fanciful creature.

3. The biodegradable memorial of claim 1, wherein the growth medium comprises saw dust, moss, straw or combinations thereof.

4. The biodegradable memorial of claim 1, wherein the first binder is water soluble.

5. The biodegradable memorial of 1, wherein the first mixture includes a second binder.

6. The biodegradable memorial of claim 5, wherein the second binder is water soluble.

7. The biodegradable memorial of claim 1, wherein the second layer is erodible in the presence of water.

8. The biodegradable memorial of claim 1, further comprising a third layer disposed between the first layer and the second layer, the third layer including one or more pigmentations.

9. The biodegradable memorial of claim 1, wherein second layer is configured for substantial erosion within 3 months.

10. A method of forming a biodegradable memorial, the method comprising the steps of:
mixing a first binder with a growth medium suitable for sustaining plant life;
compressing the growth medium to form a substantially solid core, the compressed growth medium maintaining its shape upon release;
applying a first layer over the substantially solid core, the first layer including a mixture of seeds and binder; and
applying a second layer substantially over the entirety of the first layer, the second layer comprising an erodible layer configured to erode at a first rate.

11. The method of claim 10, wherein the binder is heat or pressure activated adhesive.

12. The method of claim 10, wherein the binder is water soluble.

13. The method of claim 10, further comprising the step of heating the growth medium during compression.

14. The method of claim 13, wherein compression of the growth medium is achieved though a molding process.

15. The method of claim 10, further comprising the step of applying a third layer to the substantially solid core, the third layer including one or more pigmentation and being disposed between the first and second layer.

16. The method of claim 10, wherein the first layer is applied to the substantially solid core through a spray process.

17. The method of claim 10, wherein the second layer is applied to the substantially solid core through a spray process.

18. The method of claim 10, wherein the second layer is applied to the substantially solid core through a dipping process.

19. The method of claim 15, wherein the third layer is applied to the substantially solid core through a spray process.

20. The biodegradable memorial of claim 10, wherein second layer is configured to substantially erode within 3 months.
